(19) United States
(12) Patent Application Publication
(10) Pub. No.: US 2026/0337050 A1
(43) Pub. Date: Oct. 29, 2026

(54) METHOD FOR PREPARING VANADYL SULFATE ELECTROLYTE FROM SPENT RESIDUE HYDROTREATING CATALYST

(71) Applicants: Linqu Henghui New Materials Co., Ltd., Weifang City (CN); Shandong Xiechang Environmental Protection Technology Co., Ltd., Weifang City (CN)

(72) Inventors: Yanli Fu, Weifang City (CN); Hongyan Gao, Weifang City (CN); Yuhong Liu, Weifang City (CN); Lei Wu, Weifang City (CN); Zhijie Wang, Weifang City (CN)

(21) Appl. No.: 19/464,181

(22) Filed: Jan. 29, 2026

(30) Foreign Application Priority Data
Mar. 21, 2025 (CN) 202510336574.4

(51) Int. Cl. C01G 31/00; B01D 11/04; H01M 8/04186; H01M 8/18

(52) U.S. Cl. CPC C01G 31/003; B01D 11/0492; C01P 2006/40; H01M 8/04186; H01M 8/188

(57) ABSTRACT

Provided is a method for preparing a vanadyl sulfate electrolyte from a spent residue hydrotreating catalyst, belonging to the field of spent residue hydrotreating catalyst recycling. In the method, the spent residue hydrotreating catalyst is used as a raw material to prepare a high-purity vanadyl sulfate solution through a preparation process of “roasting-leaching-impurity removing-reducing-extracting-stripping”. On the one hand, the problem of solid waste treatment is solved, on the other hand, vanadium is selectively recovered from a high-concentration vanadium-containing solution by using a solvent extraction method, which greatly reduces the production cost. The obtained vanadyl sulfate solution has high purity, less impurity, and high production efficiency.

### CROSS-REFERENCE TO RELATED APPLICATION

This application claims priority to Chinese Patent Application No. 202510336574.4 filed on Mar. 21, 2025, which is hereby incorporated by reference in their entirety.

### TECHNICAL FIELD

The present disclosure belongs to the field of spent residue hydrotreating catalyst recycling, and in particular to a method for preparing a vanadyl sulfate electrolyte from a spent residue hydrotreating catalyst.

### BACKGROUND

Preparation methods for a vanadyl sulfate solution mainly include a chemical synthesis method, an electrolysis method, a solvent extraction method, and the like. (1) In the chemical synthesis method, vanadium oxides or vanadium salts are used as raw materials and dissolved in a sulfuric acid solution, a reducer is added, and then reduction is carried out via high-temperature heating to prepare vanadium electrolytes with different concentrations and valences. (2) In the electrolysis method, V₂O₅ or metavanadate is used as the raw material, a vanadium-containing raw material is added to a sulfuric acid solution in a cathode electrolytic cell, while H₂SO₄ of the same concentration is added to an anode electrolytic cell; when a direct current power supply is connected to the cathode and the anode of the battery, V₂O₅ or metavanadate is reduced on the surface of the cathode to obtain a low-valence vanadium solution. (3) In the solvent extraction method, a vanadium-containing solution is used as a feed solution, such as stone coal leaching solution, vanadium-titanium magnetite leaching solution, and vanadium-containing wastewater. Based on extraction selectivity of different extractants for different metals, a high-purity and high-concentration vanadium electrolyte can be prepared under comprehensive conditions including extraction, scrubbing, and stripping.

The foregoing preparation methods have the following defects. For example, the chemical reduction method has problems such as slow dissolution rate of solids and small production volume per batch, and the added reducers such as oxalic acid are difficult to completely remove, which may also generate polluting gases such as CO₂, SO₂, and Cl₂. The electrolysis method has high requirements for raw material purity and electrode performance, which features low production efficiency, high cost, and enormous energy consumption, and thus cannot meet the requirements for large-scale industrial production at present. The solvent extraction method requires multi-stage extraction, resulting in a complex process. Furthermore, this method operates with a high volume ratio of organic phase to aqueous phase (O/A) during the extraction step, while necessitating a low O/A ratio during the stripping step, leading to low overall production efficiency.

### SUMMARY

Based on the foregoing technical background, a main objective of the present disclosure is to provide a method for preparing a vanadyl sulfate electrolyte from a spent residue hydrotreating catalyst to overcome the disadvantages in the prior art.

To implement the foregoing objective, the technical solution employed by the present disclosure as follows.

The present disclosure provides a method for preparing a vanadyl sulfate electrolyte from a spent residue hydrotreating catalyst, including the following steps:
Step 1: carrying out oxidation roasting on the spent residue hydrotreating catalyst, adding soda ash for mixing, and drying; then carrying out sodium roasting, and adding water to a sodium-roasted material for leaching to obtain a vanadium-molybdenum-containing leaching solution;
Step 2: filtering and washing the vanadium-molybdenum-containing leaching solution, adding acid to regulate pH, adding alkali for saponification, extracting the leaching solution after saponification to obtain an organic phase and an aqueous phase;
Step 3: scrubbing the organic phase, then adding a sulfuric acid solution and a reducer for stripping to obtain a vanadyl sulfate solution; and
Step 4: scrubbing the organic phase after stripping, and adding alkali for molybdenum stripping to obtain a molybdenum-containing solution.

In step 1,
preferably, an oxidation roasting condition is that the oxidation roasting is carried out at a temperature of 400-800 °C for 3-8 h;
preferably, a molar ratio of soda ash to the spent residue hydrotreating catalyst after oxidation roasting is (1.05-4):1, and the number of moles of the spent residue hydrotreating catalyst after oxidation roasting is calculated as a sum of the moles of V₂O₅ and MoO₃;
preferably, a sodium roasting condition is that the sodium roasting is carried out at a temperature of 400-800 °C for 3-8 h; and
preferably, a condition for leaching by adding water leaching is that a mass ratio of the sodium-roasted material to the water is 1:(2.5-5), and leaching is carried out at a temperature of 40-90 °C for 1-4 h.

In step 2,
preferably, after filtration and washing, sulfuric acid is added to regulate pH of the vanadium-molybdenum-containing leaching solution to 1.5-2.2;
preferably, a saponification condition is that a soda ash solution or ammonium hydroxide is added for saponification at 20-30 °C, with a saponification rate of 0-80%; and
preferably, an extraction condition is that an extractant, a modifier and a diluent are added for multistage countercurrent extraction at 20-30 °C for 3-10 min with an O/A (a volume ratio of organic phase to aqueous phase) of 1:(1-10).

In step 3,
preferably, the reducer is selected from one or more of SO₂, H₂, sodium sulfite, sodium hydrogen sulfite, sodium thiosulfate, and sodium metabisulfite;
preferably, an amount of the reducer added is 0.5% to 5% of the mass of the organic phase; and
preferably, an extraction condition is that multistage countercurrent stripping is carried out at 20-30 °C for 3-10 min with an O/A of (10-1):1.

In step 4,
preferably, a condition for stripping molybdenum is that a sodium carbonate solution or ammonium hydroxide is added for molybdenum stripping at 20-30 °C for 3-10 min with the O/A of (20-1):1.

The present disclosure has beneficial effects as follows.
(1) In the method provided by the present disclosure, by taking a spent residue hydrotreating catalyst as a main raw material, a vanadyl sulfate solution is prepared from the spent residue hydrotreating catalyst. On the one hand, the problem of solid waste treatment is solved, on the other hand, vanadium is selectively recovered from a high-concentration vanadium-containing solution by a solvent extraction method, which greatly reduces the production cost.
(2) In the method provided by the present disclosure, the spent residue hydrotreating catalyst is used as a raw material to prepare a high-purity vanadyl sulfate solution through a preparation process of “roasting-leaching-impurity removing-reducing-extracting-stripping”, thereby meeting the requirements of the vanadium battery industry for the raw materials.

According to the present disclosure, by controlling the roasting and leaching conditions of the spent residue hydrotreating catalyst, the impurity content and vanadium concentration in the leaching solution can be controlled.

According to the present disclosure, impurity removal is carried out through a chemical precipitation method, which can further reduce the impurity content in the leaching solution.

According to the present disclosure, a gaseous reducer such as SO₂ is preferably used, which can avoid introducing impurities from the reducer into the vanadyl sulfate solution, so that the obtained vanadyl sulfate solution has high purity, and the production efficiency is high.

According to the present disclosure, the solvent extraction method is used for the selective separation of vanadium and molybdenum. The vanadyl sulfate solution can be directly obtained after stripping by regulating stripping process conditions. This eliminates the post-treatment process, and makes the operation more convenient.

The method provided by the present disclosure has good application prospects in the field of spent residue hydrotreating catalyst recycling and in the field of vanadyl sulfate solution preparation.

### BRIEF DESCRIPTION OF THE DRAWINGS

FIG. 1 is a diagram of a preparation process of a method for preparing vanadyl sulfate electrolyte from spent residue hydrotreating catalyst according to the present disclosure.

### DETAILED DESCRIPTION OF THE EMBODIMENTS

The present disclosure will be described in detail below, and the characteristics and advantages of the present disclosure will become clearer and more definite with these descriptions.

The spend residue hydrotreating catalyst has been listed in Catalogue of Hazardous Wastes in China (HW50), which contains a variety of rare metals, with a vanadium (V) content of generally 1% to 20% (mass fraction, the same below), a molybdenum (Mo) content of 3% to 20%, and an Al₂O₃ content of approximately 40%. The grade of the spend residue hydrotreating catalyst is much higher than that of raw ore, so that the spend residue hydrotreating catalyst is an important secondary resource with high recovery value.

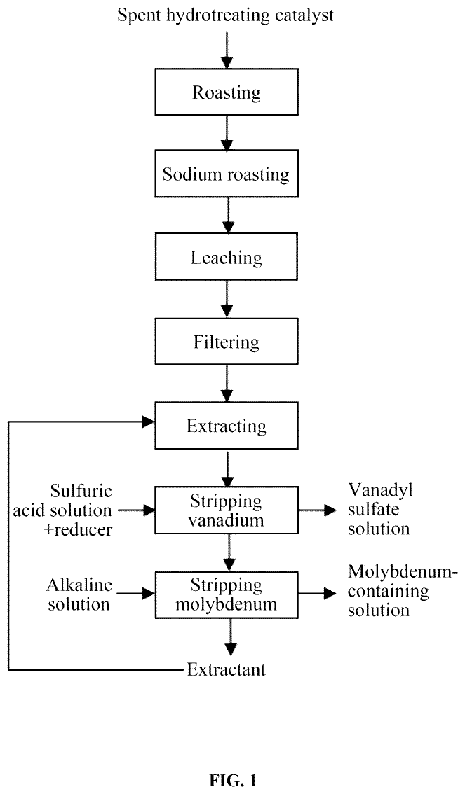

The present disclosure provides a method for preparing a vanadyl sulfate electrolyte from a spent residue hydrotreating catalyst, as shown in FIG. 1, including the following steps.
Step 1. Oxidation roasting is carried out on the spent residue hydrotreating catalyst, then soda ash is added, followed by mixing and drying; then sodium roasting is carried out, and water is added to a sodium-roasted material for leaching to obtain a vanadium-molybdenum-containing leaching solution.
Step 2. The vanadium-molybdenum-containing leaching solution is filtered and washed, then acid is added to regulate pH, and alkali is added for saponification, the leaching solution after saponification is extracted to obtain an organic phase and an aqueous phase.
Step 3. The organic phase is scrubbed, and then a sulfuric acid solution and a reducer are added for stripping to obtain a vanadyl sulfate solution.
Step 4. The organic phase after stripping is scrubbed, and alkali is added for molybdenum stripping to obtain a molybdenum-containing solution.

The foregoing steps are described in detail.

In step 1, an oxidation roasting condition is that the oxidation roasting is carried out at a temperature of 400-800 °C for 3-8 h.

Preferably, the oxidation roasting condition is that the oxidation roasting is carried out at a temperature of 550 °C for 5 h.

A molar ratio of soda ash to the spent residue hydrotreating catalyst after oxidation roasting is (1.05-4):1, and the number of moles of the spent residue hydrotreating catalyst after oxidation roasting is calculated as a sum of the moles of V₂O₅ and MoO₃.

Preferably, the molar ratio of soda ash to the spent residue hydrotreating catalyst after oxidation roasting is 2.5:1, and the number of moles of the spent residue hydrotreating catalyst after oxidation roasting is calculated as a sum of the moles of V₂O₅ and MoO₃.

A drying condition is that the drying is carried out at 110-130 °C for 1-2. Preferably, the drying is carried out at 120 °C for 1.5 h.

A sodium roasting condition is that the sodium roasting is carried out at a temperature of 400-800 °C for 3-8 h.

Preferably, the sodium roasting condition is that the sodium roasting is carried out at a temperature of 550 °C for 6 h.

A condition for leaching by adding water leaching is that a mass ratio of the sodium-roasted material to the water is 1:(2.5-5), and leaching is carried out at a temperature of 40-90 °C for 1-4 h.

Preferably, the condition for leaching by adding water leaching is that the mass ratio of the sodium-roasted material to the water is 1:4, and leaching is carried out at a temperature of 75 °C for 2.5 h.

The vanadium-molybdenum-containing leaching solution mainly includes sodium vanadate, sodium molybdate, and sodium carbonate, and has a pH value of 9-11. In the vanadium-molybdenum-containing leaching solution, a vanadium content is 10-40 g/L, and a molybdenum content is 10-40 g/L.

In step 2, after filtration and washing, sulfuric acid is added to regulate pH of the vanadium-molybdenum-containing leaching solution to 1.5-2.2.

A saponification condition is that a soda ash solution or ammonium hydroxide is added for saponification at 20-30 °C, with a saponification rate of 0-80%.

Preferably, the saponification condition is that a soda ash solution or ammonium hydroxide is added for saponification at 25 °C, with a saponification rate of 70%.

An extraction condition is that multistage countercurrent extraction is carried out at 20-30 °C for 3-10 min with an O/A of 1:(1-10).

Preferably, the extraction condition is that an extractant, a modifier and a diluent are added for multistage countercurrent extraction at 25 °C for 5 min with O/A of 1:3.

A volume ratio of the extractant to the modifier to the diluent is 10-30:0-10:60-80.

Preferably, the volume ratio of the extractant to the modifier to the diluent is 20:5:70.

The extractant is selected from one or more of TOA (Trioctylamine), N235 (Trialkylamine), N263 (Tri-alkyl methyl ammonium chloride), and TBP (Tributyl phosphate), preferably TOA.

The modifier is sec-octyl alcohol or isooctyl alcohol. The modifier can avoid the generation of a third phase.

The diluent is kerosene or DT-100.

In step 3, the reducer is selected from one or more of SO₂, H₂, sodium sulfite, sodium hydrogen sulfite, sodium thiosulfate, and sodium metabisulfite.

Preferably, the reducer is SO₂ and sodium thiosulfate.

The amount of the reducer added is 0.5% to 5% of the mass of the organic phase. Preferably, the amount of the reducer added is 3% of the mass of the organic phase.

The dosage of the sulfuric acid solution is determined according to the stripping A/O (aqueous-to-organic phase ratio). During vanadium stripping, the dosage of the reducer is based on the weight of an oil phase, or can be expressed according to a theoretical dosage excess coefficient, and the dosage of the sulfuric acid is determined according to a concentration of the sulfuric acid and the stripping A/O ratio.

The concentration of the sulfuric acid solution is 0.1-6 M. Preferably, the concentration of the sulfuric acid solution is 3 M.

A stripping condition is that multistage countercurrent stripping is carried out at 20-30 °C for 3-10 min with an O/A of (10-1):1.

Preferably, the stripping condition is that multistage countercurrent stripping is carried out at 25 °C for 5 min with the O/A of 3:1.

In step 4, a condition for stripping molybdenum is that a sodium carbonate solution or ammonium hydroxide is added for molybdenum stripping at 20-30 °C for 3-10 min with the O/A of (20-1):1.

Preferably, the condition for stripping molybdenum is that a sodium carbonate solution or ammonium hydroxide is added for molybdenum stripping at 25 °C for 5 min with the O/A of 3:1.

A stripping agent obtained after stripping can be recovered to step 2 for extraction, which is energy conservation, emission reduction, and environmental protection.

### EMBODIMENT

The present disclosure is further set forth below with reference to specific instances, these embodiments are merely used to describe the present disclosure rather than limiting the scope of the present disclosure.

### Embodiment 1

Step one. A spent residue hydrotreating catalyst was subjected to primary oxidation roasting at a temperature of 550 °C for 5 h, and then was mixed with a 30 wt % soda ash (Na₂CO₃) solution to form a loose gravel-like mixture, where a molar ratio of the soda ash to (V₂O₅+MoO₃) in the spent residue hydrotreating catalyst after oxidation roasting was 2.5:1; the mixture was dried at 120 °C for 1.5 h and then subjected to secondary sodium roasting at a temperature of 550 °C for 6 h; pure water was added into a sodium-roasted material, where a mass ratio of the sodium-roasted material to the water was 1:4, and leaching was carried out at a temperature of 75 °C for 2.5 h to obtain a vanadium-molybdenum-containing leaching solution, which mainly includes sodium vanadate, sodium molybdate, and sodium carbonate and has a pH value of 10.
Step 2. The vanadium-molybdenum-containing leaching solution obtained in step 1 was filtered and washed by using a vacuum filter, and then a pH value of the solution was regulated to 2.0 by using sulfuric acid.

At a condition of 25 °C, an extraction system was saponified with a 32 wt % soda ash solution, with a saponification rate of 70%, the saponified extraction system was added while stirring, and an extractant, a modifier and a diluent were added at the same time to obtain a mixture; the mixture was uniformly stirred, and multistage countercurrent extraction was carried out at a room temperature (25 °C) for 5 min to obtain an organic phase and an aqueous phase, where an O/A (a volume ratio of organic phase to aqueous phase) was 1:3, and a volume ratio of the extractant (TOA) to the modifier (sec-octyl alcohol) to the diluent (kerosene) was 20:5:70.
Step 3. The organic phase obtained by extraction was scrubbed, and then subjected to vanadium stripping by using a 2.0 mol/L sulfuric acid solution and the reducer, where an amount of the reducer added was 3% of the mass of the organic phase, multi-stage countercurrent stripping was carried out at a room temperature (25 °C) for 5 min, where the reducer was SO₂ and the O/A after stripping was 3:1; and a vanadyl sulfate solution was obtained by stripping.
Step 4. The organic phase after vanadium stripping was scrubbed, and then subjected to molybdenum stripping by using a 2 mol/L sodium carbonate solution with an O/A of 3:1, and multi-stage countercurrent stripping was carried out at a room temperature (25 °C) for 3 min to obtain a molybdenum-containing solution.

### Embodiment 2

Step one. A spent residue hydrotreating catalyst was subjected to primary oxidation roasting at a temperature of 500 °C for 8 h, and then was mixed with a 30 wt % soda ash (Na₂CO₃) solution to form a loose gravel-like mixture, where a molar ratio of the soda ash to (V₂O₅+MoO₃) in the spent residue hydrotreating catalyst after oxidation roasting was 4:1; the mixture was dried at 110 °C for 2 h and then subjected to secondary sodium roasting at a temperature of 500 °C for 8 h; pure water was added into a sodium-roasted material, where a mass ratio of the sodium-roasted material to the water was 1:2.5, and leaching was carried out at a temperature of 60 °C for 4 h to obtain a vanadium-molybdenum-containing leaching solution, which mainly includes sodium vanadate, sodium molybdate, and sodium carbonate and has a pH value of 9.
Step 2. The vanadium-molybdenum-containing leaching solution obtained in step 1 was filtered and washed by using a vacuum filter, and then a pH value of the solution was regulated to 1.5 by using sulfuric acid.

At a condition of 25 °C, an extraction system was saponified with a 30 wt % ammonium hydroxide, with a saponification rate of 60%, the saponified extraction system was added while stirring, and an extractant, a modifier and a diluent were added at the same time to obtain a mixture; the mixture was uniformly stirred, and multistage countercurrent extraction was carried out at a room temperature (20 °C) for 10 min to obtain an organic phase and an aqueous phase, where an O/A (a volume ratio of organic phase to aqueous phase) was 1:1, and a volume ratio of the extractant (N235) to the modifier (isooctyl alcohol) to the diluent (kerosene) was 10:10:60.
Step 3. The organic phase obtained by extraction was scrubbed, and then subjected to vanadium stripping by using a 1.0 mol/L sulfuric acid solution and the reducer, where an amount of the reducer added was 0.5% of the mass of the organic phase, multi-stage countercurrent stripping was carried out at a room temperature (20 °C) for 10 min, where the reducer was sodium thiosulfate and the O/A after stripping was 4:1; and a vanadyl sulfate solution was obtained by stripping.
Step 4. The organic phase after vanadium stripping was scrubbed, and then subjected to molybdenum stripping by using the ammonium hydroxide with an O/A of 4:1, and multi-stage countercurrent stripping was carried out at a room temperature (20 °C) for 10 min to obtain a molybdenum-containing solution.

### Embodiment 3

Step one. A spent residue hydrotreating catalyst was subjected to primary oxidation roasting at a temperature of 600 °C for 3 h, and then was mixed with a 30 wt % soda ash (Na₂CO₃) solution to form a loose gravel-like mixture, where a molar ratio of the soda ash to (V₂O₅+MoO₃) in the spent residue hydrotreating catalyst after oxidation roasting was 1.05:1; the mixture was dried at 130 °C for 1 h and then subjected to secondary sodium roasting at a temperature of 600 °C for 3 h; pure water was added into a sodium-roasted material, where a mass ratio of the sodium-roasted material to the water was 1:5, and leaching was carried out at a temperature of 90 °C for 1 h to obtain a vanadium-molybdenum-containing leaching solution, which mainly includes sodium vanadate, sodium molybdate, and sodium carbonate and has a pH value of 11.
Step 2. The vanadium-molybdenum-containing leaching solution obtained in step 1 was filtered and washed by using a vacuum filter, and then a pH value of the solution was regulated to 2.2 by using sulfuric acid.

At a condition of 25 °C, an extraction system was saponified with a 32 wt % soda ash solution, with a saponification rate of 80%, the saponified extraction system was added while stirring, and an extractant, a modifier and a diluent were added at the same time to obtain a mixture; the mixture was uniformly stirred, and multistage countercurrent extraction was carried out at a room temperature (30 °C) for 3 min to obtain an organic phase and an aqueous phase, where an O/A (a volume ratio of organic phase to aqueous phase) was 1:4, and a volume ratio of the extractant (N263) to the modifier (sec-octyl alcohol) to the diluent (kerosene) was 30:10:80.
Step 3. The organic phase obtained by extraction was scrubbed, and then subjected to vanadium stripping by using a 3.0 mol/L sulfuric acid solution and the reducer, where an amount of the reducer added was 5% of the mass of the organic phase, multi-stage countercurrent stripping was carried out at a room temperature (30 °C) for 3 min, where the reducer was sodium metabisulfite and the O/A after stripping was 1:1; and a vanadyl sulfate solution was obtained by stripping.
Step 4. The organic phase after vanadium stripping was scrubbed, and then subjected to molybdenum stripping by using a 1.0 mol/L sodium carbonate solution with an O/A of 1:1, and multi-stage countercurrent stripping was carried out at a room temperature (30 °C) for 3 min to obtain a molybdenum-containing solution.

### EXPERIMENTAL EXAMPLE

### Experimental Example 1 Composition Test

The composition tests were conducted separately on the roasted materials obtained after the primary oxidation roasting in Embodiment 1, Embodiment 2 and Embodiment 3, with test results shown in Table 1. The composition test was conducted on the vanadium-molybdenum-containing leaching solution in Embodiment 1, with test results shown in Table 2.

TABLE 1
Composition table of spent residue hydrotreating catalyst after primary roasting

| | NiO | MgO | Al₂O₃ | Na₂O | MoO₃ | V₂O₅ | Fe₂O₃ | P₂O₅ | CaO | SiO₂ |
|---|---|---|---|---|---|---|---|---|---|---|
| | (%) | (%) | (%) | (%) | (%) | (%) | (%) | (%) | (%) | (%) |
| Embodiment 1 | 9.56 | 0.03 | 56.15 | 0.34 | 2.91 | 25.38 | 3.53 | 1.81 | 0.14 | 0.14 |
| Embodiment 2 | 7.95 | 0.04 | 69.63 | 0.30 | 10.76 | 8.48 | 0.64 | 1.90 | 0.15 | 0.15 |
| Embodiment 3 | 5.74 | 0.00 | 73.76 | 0.32 | 14.93 | 2.59 | 0.52 | 1.84 | 0.14 | 0.15 |

Note:
“%” in Table 1 is mass percentage.

TABLE 2
Composition table of leaching solution

| | P | S | Mo | V | Ni | Fe | Mg | Ca | Al | Na |
|---|---|---|---|---|---|---|---|---|---|---|
| Sample | (g/L) | (g/L) | (g/L) | (g/L) | (mg/L) | (mg/L) | (mg/L) | (mg/L) | (mg/L) | (g/L) |
| Embodiment 1 | 0.13 | 3.51 | 21.30 | 11.00 | <0.10 | 0.93 | 0.75 | 0.97 | 38.60 | 25.60 |

As can be seen from Table 1 that after primary roasting, the main composition of the roasted material, excluding Al₂O₃, includes V₂O₅ and MoO₃. As can be seen from Table 2 that after adding water for leaching, the main composition of the leaching solution, excluding Al and Na elements, includes Mo and V, with relatively low contents of other elements. This indicates that the leaching solution obtained by the method of the present disclosure has few impurities, and the impurities can be removed by a chemical precipitation method, indicating that the high-purity vanadyl sulfate solution can be obtained by using this method.

The present disclosure has been described in detail above with reference to specific implementations and illustrative examples. However, these descriptions shall not be construed as limiting the present disclosure. Those skilled in the art should understand that many equivalent substitutions, modifications or improvements can be made to the technical solution of the present disclosure and implementations thereof without departing from the spirit and scope of the present disclosure, which fall within the scope of the present disclosure. The scope of protection of the present disclosure shall be subject to the appended claims.

What is claimed is:

1. A method for preparing a vanadyl sulfate electrolyte from a spent residue hydrotreating catalyst, comprising the following steps:
Step 1: carrying out oxidation roasting on the spent residue hydrotreating catalyst, adding soda ash for mixing, and drying; then carrying out sodium roasting, and adding water to a sodium-roasted material for leaching to obtain a vanadium-molybdenum-containing leaching solution;
Step 2: filtering and washing the vanadium-molybdenum-containing leaching solution, adding acid to regulate pH, adding alkali for saponification, extracting the leaching solution after saponification to obtain an organic phase and an aqueous phase, wherein
after filtration and washing, sulfuric acid is added to regulate pH of the vanadium-molybdenum-containing leaching solution to 1.5-2.2,
a saponification condition is that a soda ash solution or ammonium hydroxide is added for saponification at 20-30 °C, with a saponification rate of 0-80%;
an extraction condition is that an extractant, a modifier and a diluent are added for multistage countercurrent extraction at 20-30 °C for 3-10 min with an O/A (a volume ratio of organic phase to aqueous phase) of 1:(1-10);
a volume ratio of the extractant to the modifier to the diluent is 10-30:0-10:60-80;
the extractant is selected from one or more of TOA (Trioctylamine), N235 (Trialkylamine), N263 (Tri-alkyl methyl ammonium chloride), and TBP (Tributyl phosphate);
the modifier is sec-octyl alcohol or isooctyl alcohol; and
the diluent is kerosene or DT-100;
Step 3: scrubbing the organic phase, then adding a sulfuric acid solution and a reducer for stripping to obtain a vanadyl sulfate solution, wherein
the reducer is selected from one or more of SO₂, sodium thiosulfate, and sodium metabisulfite,
an amount of the reducer added is 0.5% to 5% of the mass of the organic phase, and
an extraction condition is that multistage countercurrent stripping is carried out at 20-30 °C for 3-10 min with an O/A of (10-1):1; and
Step 4: scrubbing the organic phase after stripping, and adding alkali for molybdenum stripping to obtain a molybdenum-containing solution.

2. The method according to claim 1, wherein in step 1,
an oxidation roasting condition is that oxidation roasting is carried out at a temperature of 400-800 °C for 3-8 h.

3. The method according to claim 1, wherein in step 1,
a molar ratio of soda ash to the spent residue hydrotreating catalyst after oxidation roasting is (1.05-4):1, and the number of moles of the spent residue hydrotreating catalyst after oxidation roasting is calculated as a sum of the moles of V₂O₅ and MoO₃.

4. The method according to claim 1, wherein in step 1,
a sodium roasting condition is that sodium roasting is carried out at a temperature of 400-800 °C for 3-8 h.

5. The method according to claim 1, wherein in step 1,
a condition for leaching by adding water leaching is that a mass ratio of the sodium-roasted material to the water is 1:(2.5-5), and leaching is carried out at a temperature of 40-90 °C for 1-4 h.

6. The method according to claim 1, wherein in step 4,
a condition for stripping molybdenum is that a sodium carbonate solution or ammonium hydroxide is added for molybdenum stripping at 20-30 °C for 3-10 min with the O/A of (20-1):1.
